(19) United States
(12) Patent Application Publication
(10) Pub. No.: US 2010/0104927 A1
(43) Pub. Date: Apr. 29, 2010

(54) TEMPERATURE-CONTROLLED BATTERY CONFIGURATION

(76) Inventor: Scott Albright, Buchanan, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/577,971

(22) Filed: Oct. 13, 2009

Related U.S. Application Data
(60) Provisional application No. 61/109,302, filed on Oct. 29, 2008.

(51) Int. Cl. H01M 10/44; H01M 10/50

(52) U.S. Cl. 429/50; 429/120; 429/62

(57) ABSTRACT

A vehicle includes a body adapted to carry passengers or cargo, an electric engine/motor, and a temperature-controlled battery configuration. The battery configuration includes a casing, and a plurality of alternating Lithium-ion cell packs and spacers defining vertical channels, the spacers supporting the cell packs in a hanging manner in the casing. The casing is flooded with a thermally-conductive electrically-insulating fluid flowing from the inlet under the cell packs, upwardly across the cell packs and out an outlet to a heat exchanger for controlling a temperature of the cell packs. A fluid pump connected to the engine/motor and a heat exchanger pumps the liquid through the system. A controller is provided for controlling the pump and fluid flow to control a temperature of the battery configuration to maintain the temperature in a desired temperature range.

This claims benefit under 35 U.S.C. §119(e) of provisional application Ser. No. 61/109,302, filed Oct. 29, 2008, entitled TEMPERATURE-CONTROLLED BATTERY CONFIGURATION, the entire contents of which are incorporated herein in their entirety.

### BACKGROUND

The present invention relates to stored-electric-energy battery configurations, and more particularly to a battery configuration allowing temperature control of battery pack, such as a lithium-ion (Li-ion) battery. In particular, the present invention relates to a temperature-controlled battery configuration such as can be used on vehicles and the like. However, a scope of the present invention is not believed to be limited to only cooling, nor to only passenger vehicles, nor to only Li-ion batteries.

Lithium-ion (Li-ion) batteries have become very popular in consumer products, particularly in cell phones, laptop computers, and portable hand-held electronic devices, due to their relatively inexpensive materials, high energy density, high pulse current outputs over a significant temperature range, and excellent energy storage characteristics (such as low energy loss over time and minimal memory issues). However, safety issues and also durability issues have limited their use in electric-driven passenger vehicles.

Specifically, several problems must be addressed before Li-ion batteries can be safely used in a passenger vehicle. For example, Li-ion batteries can rupture, ignite, and/or explode when exposed to high temperature environments, for example, when used in an area that is prone to prolonged direct sunlight and/or high temperature (such as in parked vehicles). Further, short-circuiting of a Li-ion battery causes them to discharge rapidly, thus also potentially causing them to ignite or explode, particularly when large Li-ion battery systems are being used. For example, several well-publicized consumer recalls for defective Li-ion batteries have been conducted as a result of these reasons. Additional safety issues of battery-electric vehicles are generally detailed in the international standard ISO 6469, including concerns over on-board electrical energy storage of large amounts of energy, functional safety issues including protection against failures, and protection of persons against electrical hazards. It is noted that some components of Li-ion batteries are relatively mechanically fragile and are adversely affected by vibration and/or other mechanical forces from such things as road vibrations, impacts, bumps, and accidents, as well as by thermal cycling, temperature extremes, and inter-component shifting movement due to different thermal expansion rates and also due to stopping and starting of the vehicle.

Additional problems include battery complexity, weight, high initial costs, and high end-of-life costs. Complex battery configurations are expensive due to the number of components and difficulty in assembling them. Further, complexity leads to other problems, such as tolerance stack-up issues leading to product variation, mismatched thermal expansion, and warranty problems. Also, battery complexity can cause the battery to become heavy as non-energy-producing components are added to the design, which is particularly problematic in vehicles. Another problem is the high end-of-life cost for properly disposing of used-up batteries.

There are some battery systems that employ temperature control using a gas or liquid. In gas cooled systems, gas is passed around and/or through the battery cells and/or battery case to carry away heat. For example, batteries used in some Toyota automobile electric drive systems are cooled at least in part by forced air around the batteries. However, air is inefficient as a coolant fluid because it has low heat-carrying capacity, and further air requires passageways that are open, relatively unobstructed, and able to pass significant volumes of gas. In the liquid cooled systems, liquid is passed along or within battery case or across battery cells, however they require a thermally-conductive electrically-insulating solid material to separate the liquid from the battery cells. Fundamentally, these second systems are based on containing the liquid (i.e., preventing contact between electrically charged portions of a battery and the liquid) in a closed loop system. However, leaks are a problem for several reasons, such as 1) leaks cause liquid to be lost to the system and hence result in an inability to cool the battery, 2) leaks may allow liquid to contact an electrically active portion of the battery thus creating a short circuit and/or power loss, 3) liquid containment that is reliable and robust is also quite expensive, and further requires assembly of pipes, connections, significant laborious manual assembly, quality control, post-assembly testing, expensive components, etc. Further, these systems are not robust and hence are prone to leakage either immediately or over time (especially due to the rough/harsh environment of vehicles). For example, automobiles are subject to substantial abuse due to temperature fluctuations, vibration and physical bumps/movement, difficult engineering decisions caused by location and placement within the vehicle, physical wear and tear due to environmental factors and due to forces including moisture, dust, material degradation, freezing of moisture, dissimilar thermal expansion, and many other factors.

### SUMMARY OF THE PRESENT INVENTION

In one aspect of the present invention, a battery configuration includes a plurality of battery cells, a battery case defining a space and housing the battery cells, and a thermally-conductive electrically-insulating liquid flooding the space and coating the battery cells for conducting heat away from the battery cells while maintaining electrical integrity.

In another aspect of the present invention, a temperature-controlled battery configuration includes a plurality of battery cells, with conductive electrodes for accessing electrical power capacity of the cells, a system of interconnecting hardware that allows multiple cells to function together as an electrical storage battery, a control system including circuitry that is electrically connected to the cells for at least one of monitoring or controlling the battery configuration, a container sized and shaped to contain and encapsulate the cells along with the system of interconnecting hardware and at least a portion of the control system, and an electrically-insulating heat-transfer liquid filling the container and having direct contact to the cells, the hardware, and the portion of the control system in the container.

In another aspect of the present invention, a temperature-controlled battery configuration includes a plurality of standard Lithium-ion cell packs with conductor tabs for accessing electrical power stored in the cell packs, a spacer between and separating adjacent ones of each of the cell packs, the spacer having a perimeter that holds at least a part of a weight of the adjacent cell packs and that defines with the adjacent cell packs a plurality of channels, positive and negative electrical conductors connecting the conductor tabs, and a case for containing the cell packs, spacers, and conductors, and being adapted for connection to a pump and heat exchanger, the case including an inlet and outlet connected to the channels for passing electrically-insulating thermally-conductive fluid therethrough.

In another aspect of the present invention, a temperature-controlled battery configuration includes a battery including a casing with an inlet and an outlet, and a plurality of standard Lithium-ion cell packs with channels therebetween positioned in the casing, the channels being adapted to communicate an electrically-insulating thermally-conductive fluid from the inlet past the cell packs to the outlet for controlling a temperature of the cell packs including directly impinging the fluid against outer surfaces of the cell packs, a pump, a heat exchanger, and fluid lines operably connecting the pump, the inlet, the outlet and the heat exchanger; the lines being filled with the thermally-conductive fluid.

In another aspect of the present invention, a vehicle includes a vehicle body with wheels and seating that is adapted to carry passengers and/or cargo, an electric battery-powered engine for powering the vehicle, a temperature-controlled battery configuration comprising a battery including a casing with an inlet and an outlet, and an alternating arrangement of Lithium-ion cell packs and spacers with at least one spacer between each of the cell packs, the spacers supporting at least part of a weight of the cell packs in the casing, the spacers further defining with adjacent ones of the cell packs a plurality of channels, a thermally-conductive electrically-insulating fluid for passing into the inlet, along the channels and against an outer surface of the cell packs, and to the outlet for controlling a temperature of the cell packs, a fluid pump for pumping the fluid, a heat exchanger for controlling a temperature of the fluid, fluid lines operably connecting the pump, the inlet, the outlet and the heat exchanger; the lines being filled with the thermally-conductive fluid, and a controller for controlling the pump and flow of the fluid to control a temperature of the battery configuration to maintain a desired temperature range of the cell packs.

In another aspect of the present invention, a method of regulating temperature in a multiple-cell battery comprises steps of providing a battery with multiple cells spaced apart by spacers, at least a part of a weight of the cells being supported by the spacers and a combination of the cells with adjacent ones of the spacers forming fluid-conducting channels, providing an electrically-insulating heat-transfer fluid, passing the fluid through the channels past an outer surface of each of the cells under adjacent ones of the spacers at a rate sufficient to regulate cell temperature, including deliberately and directly impinging the fluid against the outer surfaces of the cells, but with the fluid not significantly interacting with the cell's electrical charge nor detrimentally affecting the cell's materials of construction, and controlling a temperature of the fluid to achieve temperature control of the cells.

An object of the present invention is to apply heat transfer liquid directly on the cell packs.

An object of the present invention is to provide spacers that support and hold the cell packs.

The present inventive concept not only accepts the direct contact of cooling liquid with the inner workings of the battery apparatus, but encourages it. The proper selection of a heat transfer liquid that is also electrically insulating allows the present design to dispense with many of the barriers and containment components found in existing battery designs, since a barrier is NOT needed to prevent contact between the electrical portion of the battery and the heat transfer liquid. Further, the entire battery assembly can be flooded, including the cells, cell interconnects, and ancillary control and monitoring circuitry. The present liquid allows all of these components to be temperature controlled. Ancillary benefits are that the flooded parts are protected from corrosion, contamination (such as leaks that let moisture into the assembly), vibration, and electrical arcing.

These and other aspects, objects, and features of the present invention will be understood and appreciated by those skilled in the art upon studying the following specification, claims, and appended drawings.

### BRIEF DESCRIPTION OF DRAWINGS

FIG. 1 is an exploded perspective view of battery cell packs separated by spacers and including conductive and non-conductive slugs for selectively interconnecting input/output tabs on adjacent cell packs, two of the lithium ion cell packs and two spacers being shown.

FIGS. 2A-2B are perspective views of front and rear faces of a subassembly of two cell packs and two spacers from FIG. 1, and FIG. 2C is a cross section taken along lines IIC-IIC in FIG. 2B.

FIG. 3 is an exploded perspective view of an 18 cell stack including 18 cell packs, 17 spacers, 2 end plate spacers, an integral top-mounted circuit board, and clamps and bars.

FIG. 4 is a fragmentary exploded view showing an underside of the circuit board and cell stack, the circuit board being in-line for attachment to a top of the cell/spacer stack in FIG. 3.

FIGS. 5-6 are top and bottom perspective views of an 18 cell stack subassembly like FIG. 3 with circuit board, end plates, and clamp bars attached.

FIG. 7 is a perspective view of an interconnected group of three subassemblies of FIG. 5.

FIGS. 8-10 are perspective views of the interconnected group of FIG. 7 positioned in a battery case to form a battery configuration, FIG. 8 being without primary battery terminals, FIG. 9 being with primary battery terminals, and FIG. 10 being with a top cover in place.

FIG. 11 is an enlarged fragmentary bottom perspective view of FIG. 4 showing flow of electrically-insulating liquid along a bottom channel upwardly into vertical channels in the 18 cell/spacer stack.

FIG. 12 is a perspective view of FIG. 10, part of the side and top of the battery case broken away to reveal liquid flow within the battery configuration, FIG. 13 being an enlarged view of the circled area XIII, and FIG. 14 being an enlarged view of a top area from FIG. 12 (above FIG. 13), FIG. 14 showing an outer edge of the spacers and also the top of the battery case removed to better show internal components.

FIG. 15 is a side perspective view similar to FIG. 2B but showing the battery case (including its top) and showing the circuit board, and also showing the flow of electrically-insulating thermally-conductive fluid along a bottom channel upward into vertical channels and out a top of the 18 cell stack, the shaded area showing areas flooded by the electrical insulating liquid.

FIG. 16 is a side view of FIG. 10.

FIGS. 17-19 are cross sections taken along lines XXVII, XVIII, and XIX in FIG. 16.

FIG. 20 is an enlargement of a left/lower corner portion of FIG. 19, FIG. 20A is an enlargement of the circled area XXA in FIG. 20, and FIG. 21 is an exploded side view showing two spacers and two battery packs within the battery case of FIG. 20.

FIG. 22 is a cross section taken along line XXII in FIG. 16.

FIG. 23 is an enlargement of the circled area XXIII in FIG. 22, and FIG. 24 is a fragmentary exploded view of two spacers shown in FIG. 23.

FIG. 25 is a schematic view of a vehicle incorporating the present battery apparatus as part of a battery driven system, including the battery apparatus, an electric motor, a pump, fluid lines connecting same, sensors, and a controller for controlling battery temperature.

### DETAILED DESCRIPTION OF PREFERRED EMBODIMENTS

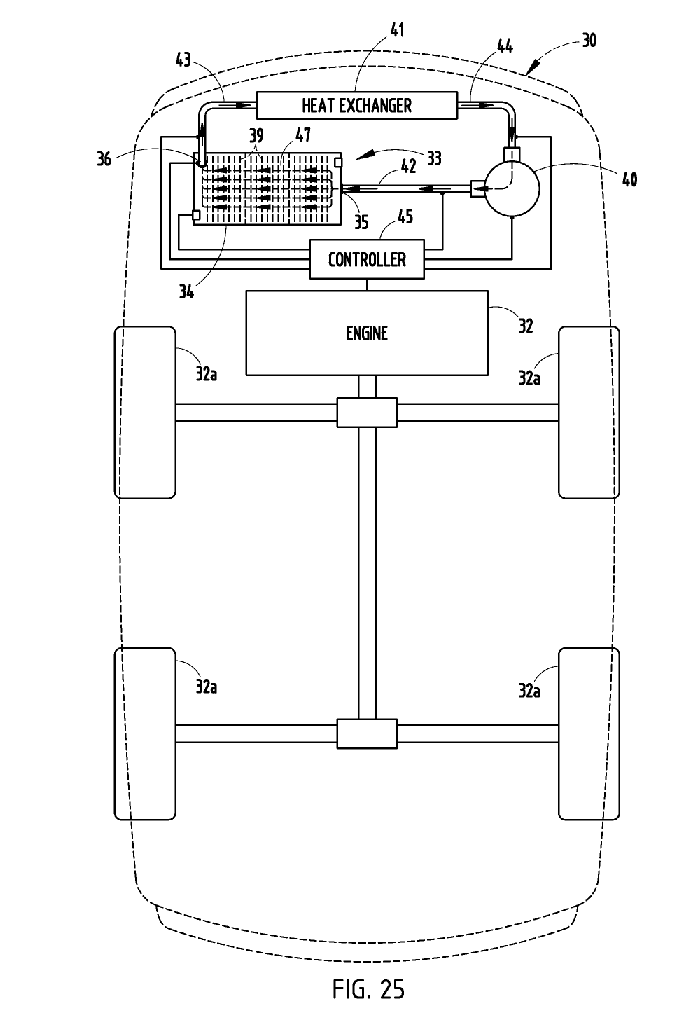

A vehicle 30 (FIG. 25) includes a vehicle body 31 adapted to carry passengers and/or cargo, and an electric battery-powered motor 32 for driving vehicle wheels 32A. A temperature-controlled battery configuration (also called “battery apparatus”) on the vehicle comprises a battery assembly 33 including a case 34 (also called “battery casing” or “container” or “enclosure”) with a liquid inlet 35 and a liquid outlet 36, and a plurality of standard Lithium-ion cell packs 37 separated by spacers 38 positioned in the case 34. The cell packs 37 and spacers 38 define a plurality of channels 39 therebetween, with the spacers 38 carrying at least a part of the weight of the cell packs 37. The channels 39 are adapted to communicate an electrically-insulating thermally-conductive liquid 47 from the inlet 35 along sides of the cell packs 37 to the outlet 36 for controlling a temperature of the cell packs 37. A fluid pump 40 is driven by the electric motor 32, and motivates the liquid 47 through a heat exchanger 41 and along fluid lines 42-44 that operably connect the pump 40, the inlet 35/outlet 36 and the heat exchanger 41. A controller 45 connected to a circuit board 46 within the case 34 is provided for controlling the pump 40 based on sensors within the battery to optimally control liquid flow to maintain the temperature of the battery assembly 33 in a desired temperature range. It is contemplated that the circuit board 46 incorporates parts of the control circuit, and that sensors and connectors can be placed on a top of the battery stacks for connecting various cell packs, as described below. Notably, the liquid 47 also cools the circuit board 46 and other electrical components within the casing as well via a flooded liquid arrangement, as described below.

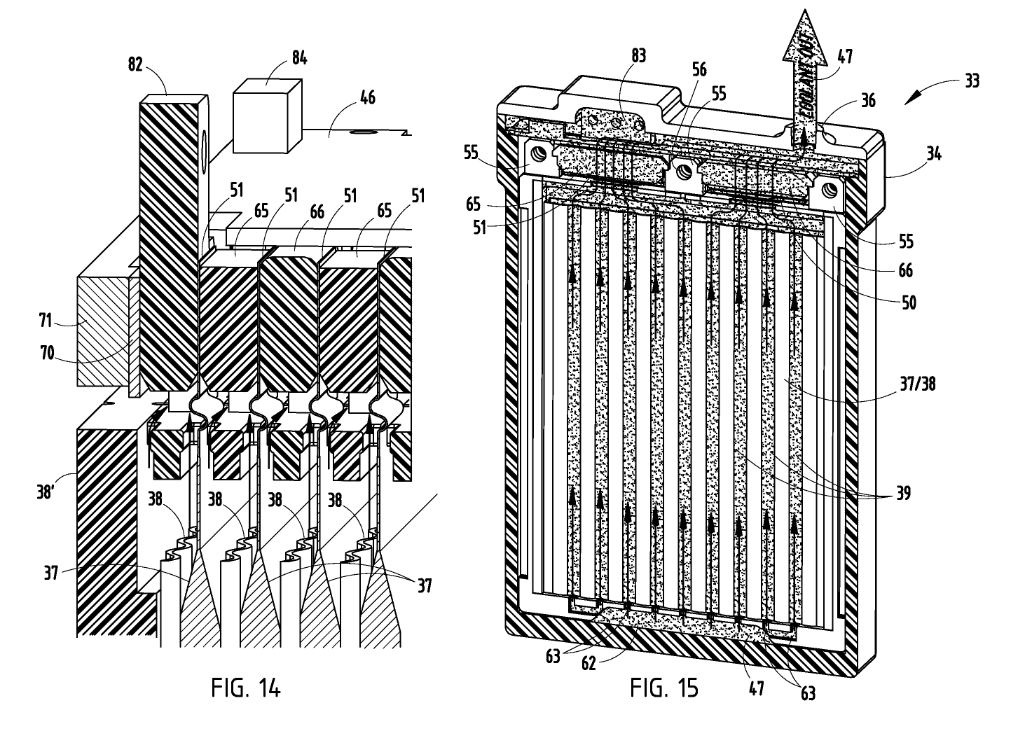

The electrically-insulating thermally-conductive liquid 47 (FIG. 15) floods an interior of the case 34, filling voids under, through, and above the cell packs 37, and flooding areas around the integrated circuit board 46. A preferred liquid 47 is a heat transfer liquid such as is sometimes used in ground-attached stationary transformers. For example, the NF series of electrically-non-conductive thermally-conductive heat transfer liquid made by Paratherm™ Company would work for this present innovative system.

The present design addresses six areas in particular:

1) The present system is efficient, robust, and uses a cost effect liquid for heat transfer. Li-ion battery packs require cooling in order to increase the power density to a practical level for many applications, particularly mobile ones such as are required for driving passenger vehicles. Known cooling techniques typically place coolant or cooling bodies in close proximity to the cells in an attempt to improve heat transfer density to the cooling medium and to isolate the cells from direct contact with the coolant. In the present configuration, complexity of the cooling system is eliminated or reduced by not only allowing, but encouraging, direct contact between the cooling media (liquid coolant) and the cell's structure. This is achieved by selecting a coolant that is both capable of absorbing a high density of thermal energy and that possesses a high dielectric value (electrical insulating value), allowing it to make direct contact with energized electrical circuits. Typical coolants would include paraffin-based heat transfer fluid, such as “transformer oil.” This allows the elimination of the conduits normally required to isolate fluid from the cells, allowing tighter cell spacing, higher energy transfer rate, higher power/mass density, and related advantages.

2) The present system is adapted to effectively handle vibration and physical requirements in a battery-powered vehicle. Cooled Li-ion batteries in mobile applications such as passenger vehicles are subject to high G-forces across a wide frequency spectrum. This is detrimental to the typical cell's construction due to fragility of components and the system's sensitivity to same. High levels of vibration (frequency and amplitude) also complicate the application of typical liquid-cooled systems because it becomes difficult to prevent leaks in the cooling circuit's plumbing. Leaks in known systems typically lead to electrical circuit failure, corrosion, and other detrimental effects.

The present concept requires no sealing amongst or between the battery cells. Liquid coolant circulates within a sealed battery enclosure (also called “container” or “casing”) via flooding and broad-based fluid current. The enclosure need only be sealed to prevent liquid coolant spillage along one easily-accessible mating seam and at the two main connections to the circulatory system. This is not unlike an anti-freeze coolant system seen for cooling engines in a conventional automotive cooling system, such that workers at vehicle assembly plants are able to deal with the present system. Besides the drastic reduction of leak potential, the present concept allows the liquid coolant to “cushion” or damp the motion of the cells, which greatly reduces mechanical loads on the cells, prolonging their life and reliability.

3) The present system is relatively lightweight as well as low cost. The materials of construction in a typical liquid-cooled Li-ion cell pack are relatively expensive and heavy. A framework is required to hold the cells in place in the assembly. Typically, great effort is made to improve heat transfer rate out of the pack, requiring the use of large amounts of thermally conductive materials such as aluminum and copper. These materials must be made heavy enough to withstand high G-loads and handle possible internal fluidic pressure without leaking. Since the structural materials used in our concept are not required to conduct heat, nor are they required to isolate fluids or retain high fluid pressure, the present concept can potentially use a light and inexpensive material like plastic for our framework. For example, expanded polystyrene is believed to be an ideal material due to its very low mass and low expense. It also helps to dampen mechanical vibrations, which were described as detrimental to the cells in the previous section. It is contemplated that the spacers can alternatively be a perimeter frame (without center folds or even without a center panel) or plate (no weight-bearing perimeter frame).

4) The present system is well designed for the environment of a vehicle, including ability to allow material swelling, dissimilar thermal expansion, low complexity, design flexibility including adaptability and integration. It is a typical attribute of Li-ion cells that they begin to “swell” somewhat unpredictably as they age. In cell-pack designs that we have researched, this swelling is accommodated by including compliance devices within the battery assembly. Examples to accommodate this swelling includes using springs to mount the cells to the structure, using rubber mats or pads to hold the cells in place, or simply leaving spaces between cells in the assembly. This introduces additional weight and/or complexity and/or space to the battery design. Our concept addresses this problem by integrating inexpensive compliant features directly into the framework and its mounting system for the cells, which in the illustrated embodiment are depicted by convolutions in the polystyrene spacers. This allows the cells to swell, while maintaining good cooling fluid contact, and yet also providing mechanical support. Once again, this structure also provides some degree of mechanical damping.

5) The present system is repairable, and/or can be refurbished, and/or can be broken down at end-of-life, yet is sufficiently flexible to allow various battery configurations and designs. The currently available Li-ion batteries that we have researched are virtually unrepairable, and also have a high end-of-life cost. The electrodes of most cells in batteries are often welded, soldered, riveted, etc., which makes the process of dismantling the assembly difficult. Repair of a faulty battery is usually impossible. Because of the complexity of the typical battery structure and the unforgiving nature of the assembly techniques used, production and scrap costs are also high. We propose a simple system of both conductive or insulating bodies (called slugs in our illustrations) to connect the cells within the battery. The electrodes of a typical Li-ion cell are intermingled with various stacks of conductive and insulating slugs and then clamped together using some simple, long screws. By rearranging the positions of the slugs within an assembly it is possible to configure a battery for a multitude of voltage or current capacities to tailor the assembly to its application. This allows many variations in product without any change to the constituent parts or the assembly techniques. Also, an assembly may now be easily disassembled by removing a few screw fasteners, then reassembled. These attributes facilitate assembly, reduce scrap in production by allowing re-work, allow field repairs of the assembly, and reduce end-of-life costs by allowing the battery to be disassembled and the constituents recycled, to name a few.

6) The present system integrates electronic control for safety, low-cost assembly, compactness of design, modularity, durability, and long life of the battery configuration, as well as providing cooling for the electronic hardware itself. Li-ion cell assemblies must be monitored and controlled by supervisory electronics in order to be used safely. These electronics sometimes are connected to the cell electrodes to measure voltage, and may also measure temperature. This is an expensive and complicated undertaking in the products that we have researched, because the electrical connections are usually a less accessible attribute of any cooling apparatus. It is difficult to measure temperature of cells within a battery case without interfering with the cooling system. Finally, consideration should be made to the potential interactions between the control circuitry and stray coolant, which in prior art systems is conductive, corrosive, and/or both. Our proposal is to immerse the control electronics in the same coolant fluid bath as the rest of the assembly. The coolant bath will actually protect the circuitry from environmental influence. Coolant leakage is not a consideration. Because the illustrated “slugs” interconnect adjacent cells, making an electrical connection is as simple as touching a contact from the circuit to the appropriate slug(s). Temperature can be measured at any point by placing a temperature transducer in the exiting coolant flow, such that the flow impinges upon the transducer. The circuitry shown in our illustrations would be able to be replaced or repaired without disassembly of the battery. These considerations should dramatically reduce production costs, and improve battery performance and reliability.

Notably, one liquid 47 that will work satisfactorily is the NF series of heat transfer liquids made by Paratherm™ Company. The HF series liquids are a good fit for the present inventive system because they are non-toxic and relatively inexpensive, and further they operate over a good temperature range. Notably, the MSDS and engineering data sheets are available on the internet, and this data is incorporated herein by reference to the extent that it is necessary for an understanding of the present inventive concepts. It is noted that further improvements in the liquid could be made by working with a company like Paratherm™ to select (or formulate) the best liquid for the application.

The present arrangement as discussed above acts to cool the vehicle energy storage batteries; however, more generally it is characterized as a “temperature regulation” mechanism since it can also be used to warm up (i.e., heat) the vehicle energy storage batteries as well. For example, the present arrangement can be “reversed” for heating the battery cells to an optimal/efficient starting operating temperature range and/or optimal energy storing temperature. Our proposed design can easily work for this purpose by passing liquid 47 that is WARMER than the cells into the assembly.

The present system floods an interior of the battery apparatus with Paratherm™ liquid coolant (47), including the cell packs, the circuit board, and other electrically conductive components within the battery case. The liquid 47 is pumped at whatever rate is necessary for heat dissipation. It is noted that the present Paratherm™ liquid coolant is a very good heat sink, such that a velocity/speed of flow does not have to be large for normal operation. For example, in the illustrated battery apparatus when sized for a vehicle, it is contemplated that the liquid flow can be as low as about 20 cc per minute, which under expected battery usage absorbs sufficient heat to maintain an internal battery temperature of about 80 to 90 degrees Fahrenheit (including circuitry).

It is noted that a wide number of variations are believed to be within the present inventive concept. For example, the spacers/supports described above could be replaced with simple aluminum plates that are interstitially placed within a (linear or circular) stack of cells. The aluminum plates would conduct heat from the cells to the liquid at whatever locations the liquid bath is present. Notably, some Lithium-ion cells are round cylinders. It is noted that the present concept can be adapted for round cylinders as well.

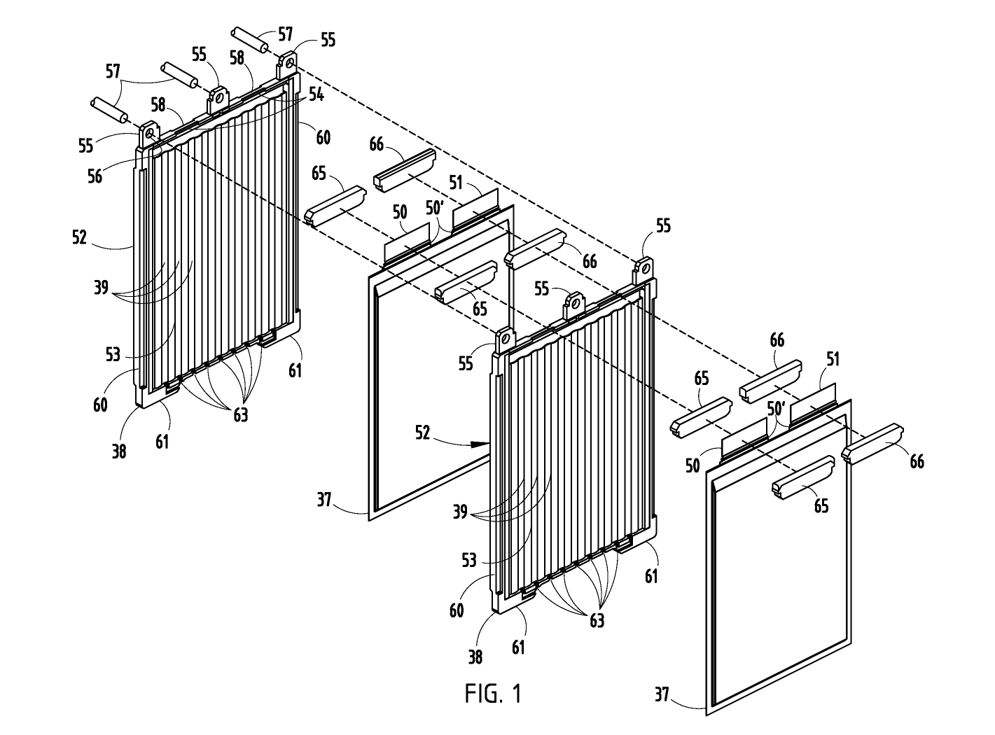

The illustrated cell packs 37 (FIG. 1) are Lithium-ion type cells and are flat panel-shaped members including front and rear insulating sheets bonded together around their perimeter with layers of electricity-producing materials, the layers being arranged to communicate electrical potential to the cathode and anode leads 50 and 51 at a top of the packs 37. Leads 50 and 51 are tab-like flat flanges with horizontal undulations 50′ at their base. The leads 50 and 51 form large flat contact areas for the cells packs 37. The cell packs 37 hang from a top of the cell stacks. The leads 50 and 51 include undulations at their base that form a mechanical strain relief for allowing dissimilar thermal expansion and also for shock absorption in the system. In particular, the undulations “mechanically decouple” the leads 50 and 51 from the cells to a certain extent, so that a body of the cell packs 37 are less subject to mechanical vibration and stress.

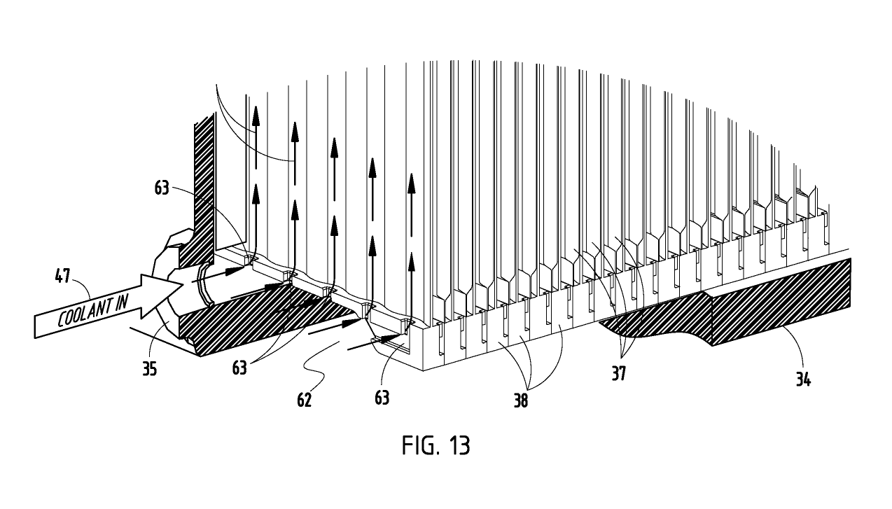

The spacers 38 (FIG. 1) each include a perimeter frame 52 surrounding a corrugated/multi-folded inner sheet 53. The folds in the inner sheet 53 form the vertical channels 39 adjacent the surface of the cell packs 37 for liquid flow when placed against a cell pack 37. The perimeter frame 52 of the spacers 38 includes top structural tabs 55 with holes 56 for receiving support rods 57, and further includes a horizontal top frame member 58 shaped to grip a top of an adjacent cell pack 37. When compressed with other spacers 38, the cell packs 37 hang in the assembly like window shades or curtains hanging from a window curtain frame. The top frame member 58 includes recesses forming channels 54 for liquid 47 to flow upwardly from the channels 39 to the space between and around tabs 55. A horizontal bottom frame member 59 is supported by side frame members 60 and includes feet 61 for providing support to the perimeter frame 52 from the floor of case 34. The bottom frame member 59 defines a bottom longitudinal center space 62 between the feet 61 that forms a channel for cooling liquid 47 to flow from end-to-end of the battery case 34 (see FIG. 12), and also includes apertures or slots 63 allowing the cooling liquid 47 to flow vertically up into each of the channels 39 from the bottom space 62.

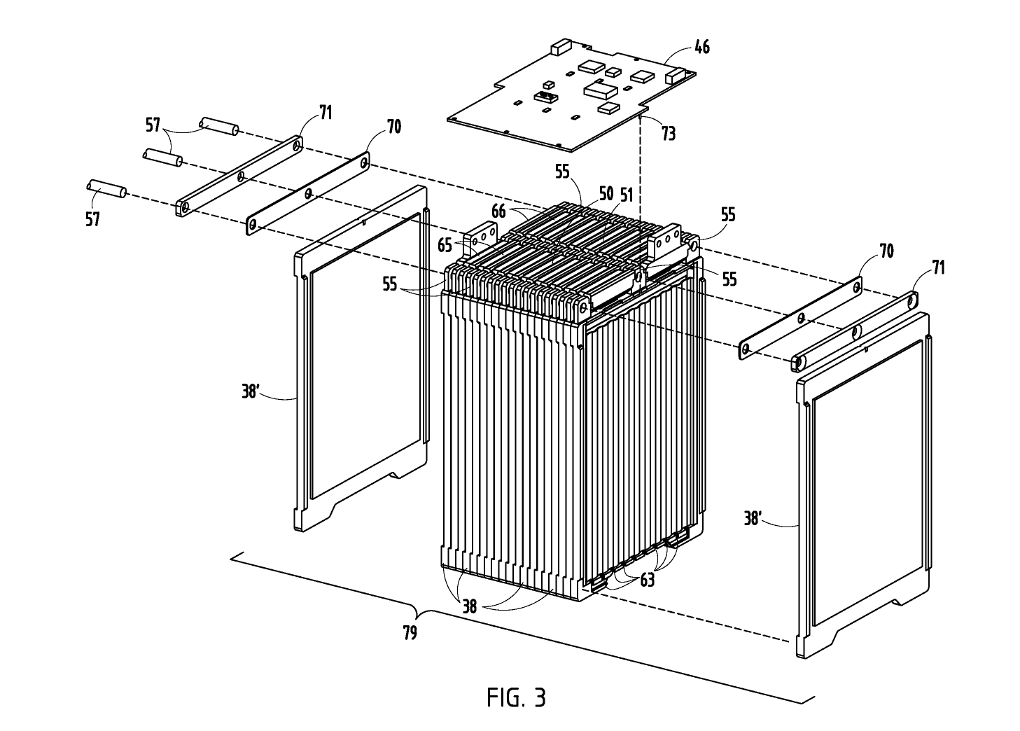

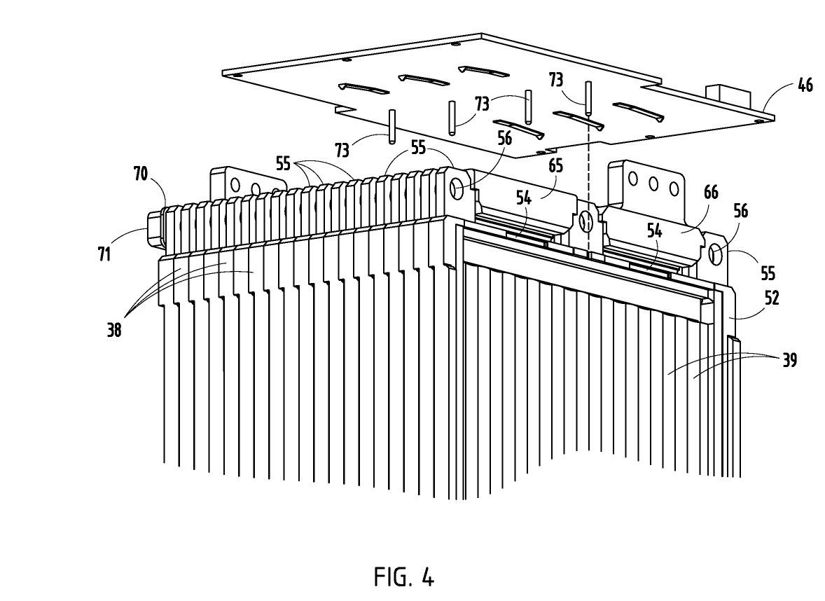

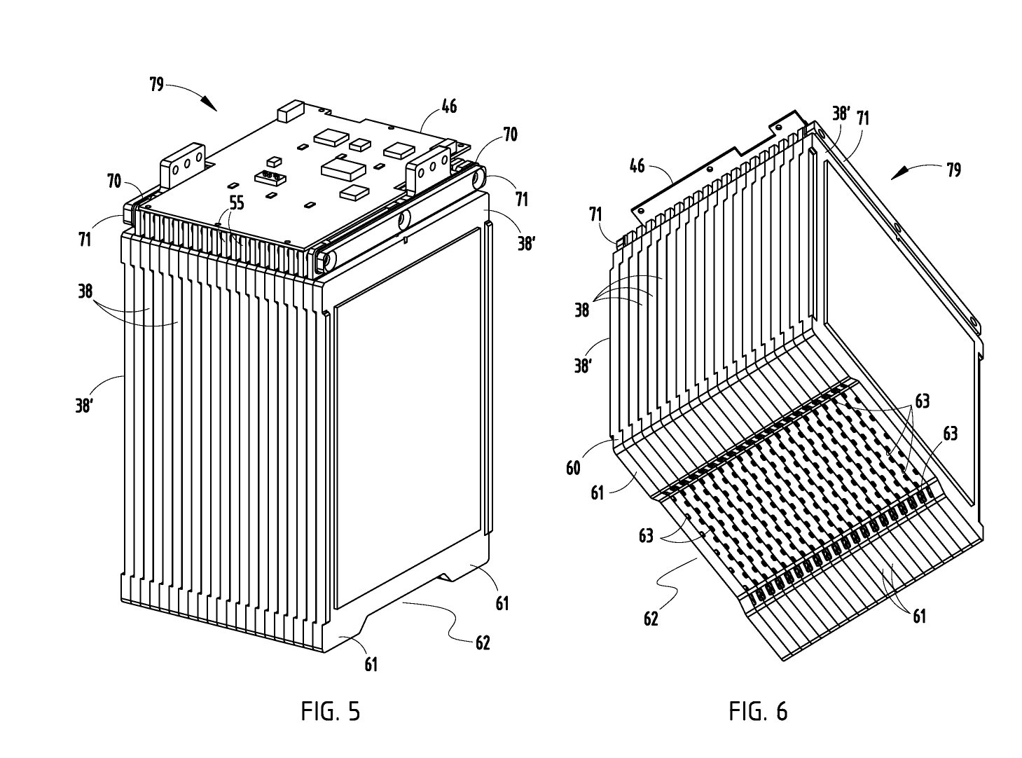

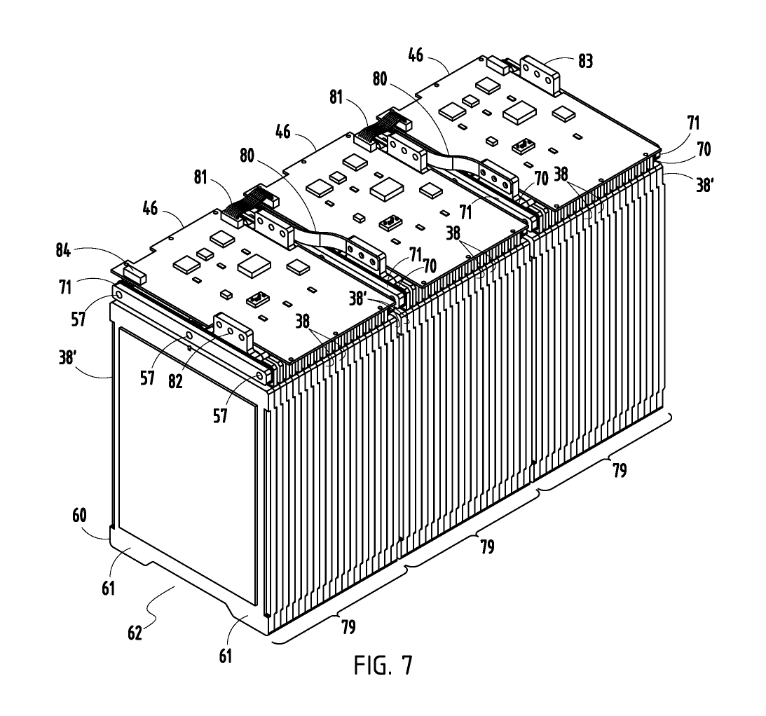

Conduction and insulation slugs 65 and 66 are configured to engage and interconnect (or electrically separate) the leads 50 and 51 when in the clamped arrangement (see FIG. 3) for communicating electrical energy from one cell pack to the next in a desired sequence. They can be arranged for additive/serial coupling (where voltage of each cell pack adds to the next) or parallel coupling (where voltage remains the same, but amperage capacity is increased). In other words, they can be arranged in many different configurations for different battery requirements, such as to provide desired voltage and amperage capabilities. The spacers 38 support a weight of adjacent cell packs 37, and further their folds and convolutions support and also cushion the cells as well as facilitate flow of cooling liquid 47.

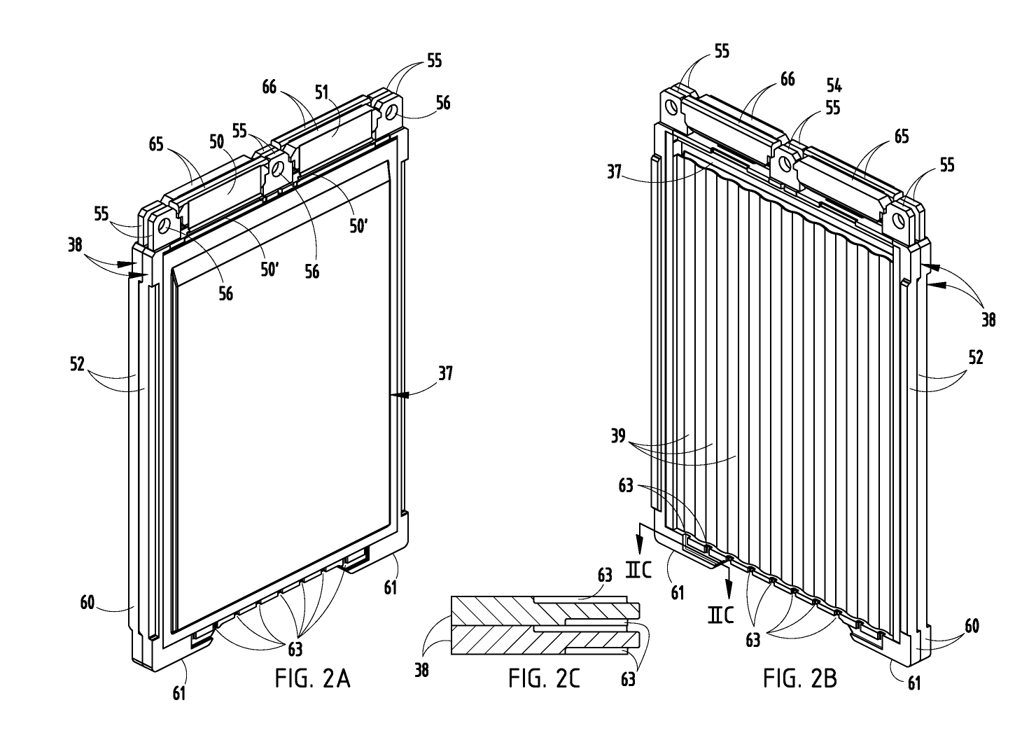

FIG. 2 is a perspective view of a front face of a first subassembly of cell packs and spacers from FIG. 1, and also shows a rear face of a second similar subassembly ready to assemble together.

FIG. 3 is an exploded perspective view of an 18 cell stack including eighteen cell packs 37, seventeen spacers 38 (and two end spacers 38′), two end plates 70, and two clamp bars 71 along with tie rods 57. The slugs 65 and 66 are arranged to obtain the desired voltage and current capacity. The plates 70 and clamp bars 71 are drawn together by rods 57 (or screws and nuts) that compress the flanges 50 and 51 and slugs 65, 66 together for the desired electrical connection. The end spacers 38′ provide added strength to facilitate integration with neighbor cell stacks. The circuit board 46 includes heat sensors 73 that extend into the flood-pooled cooling liquid 47 within the battery case 34. The circuit board 46 also includes voltage sensors for system control. Thermistors and spring contacts are mounted to an underside of the circuit board 46. The thermistors provide a measurable temperature reading as they are impinged upon by the flow of coolant liquid 47. Contacts push against select slugs for sensing voltage and current flow and also can be used for powering the circuit on the circuit board. The circuit board 46 also includes various items as needed, such as voltage test points, slugs for connection to drive circuitry, and communications network connector(s) (such as for connection to a vehicle engine/power-plant control system.

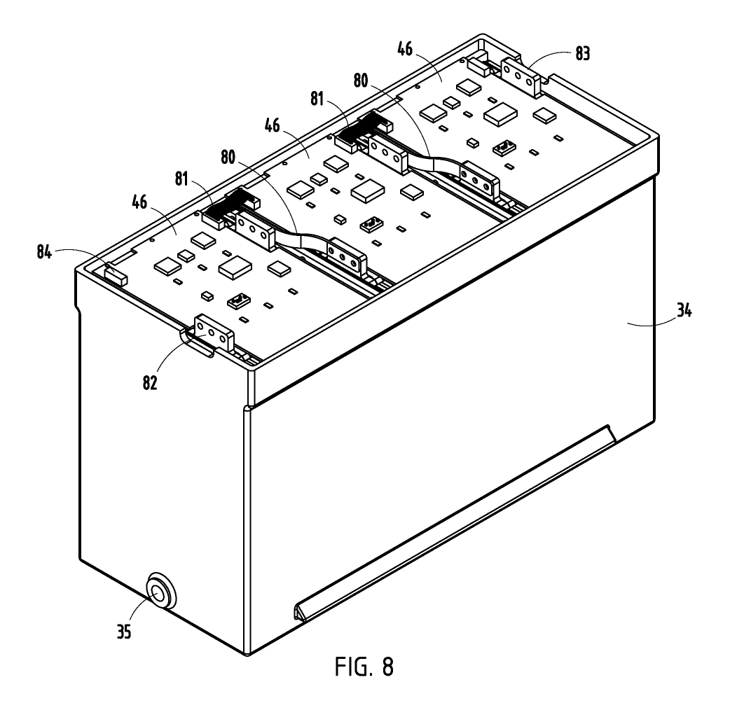

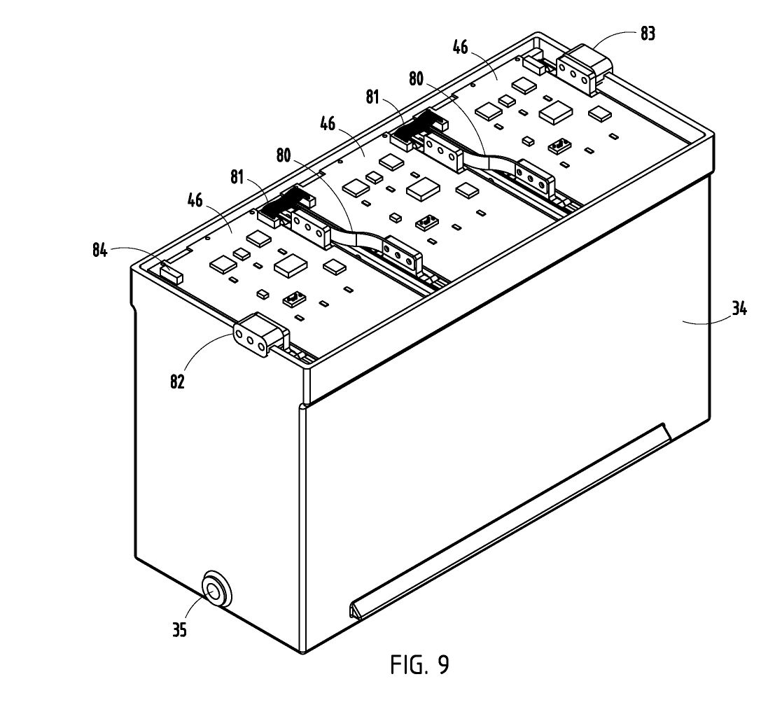

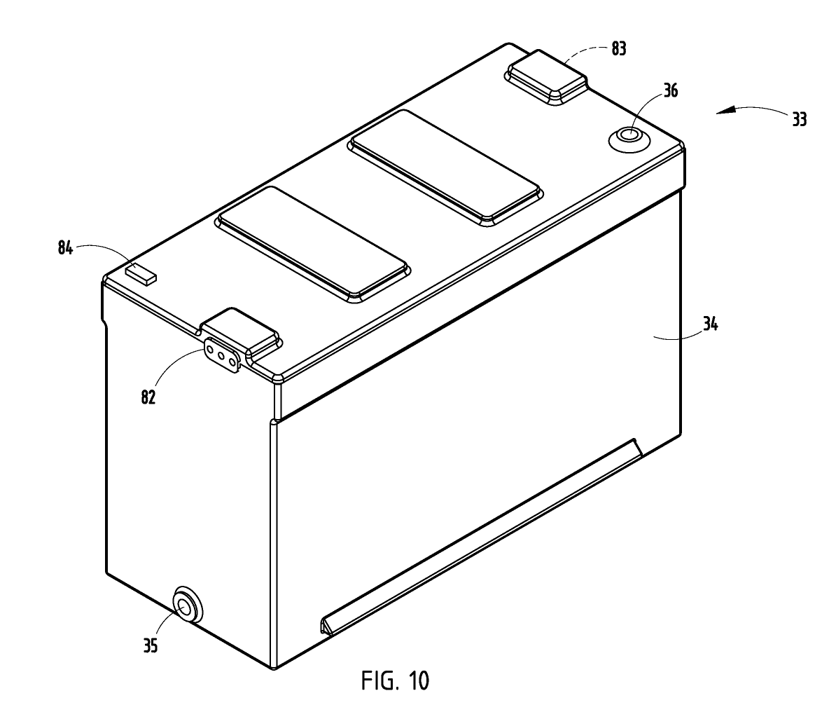

FIG. 7 is a perspective view of an interconnected group of three cell stack subassemblies 79 shown in FIG. 5, the three subassemblies being shown positioned end-to-end together and interconnected by jumpers 80 that electrically interconnect the battery cell packs. The circuit boards 46 of each cell stack are also interconnected by multi-lead connectors 81 for electronic control. Master positive and negative terminals 82 and 83 (FIGS. 9-10) are attached to outer ends of the interconnected subassemblies, thus providing drive power connections. At least one external communication connector 84 is positioned in the top of the case 34. Notably, FIGS. 8-10 are perspective views of the interconnected group of FIG. 7 positioned in a battery case to form a battery apparatus, FIG. 7 being without primary battery terminals, FIG. 8 being with primary battery terminals, and FIG. 9 being with a top cover in place.

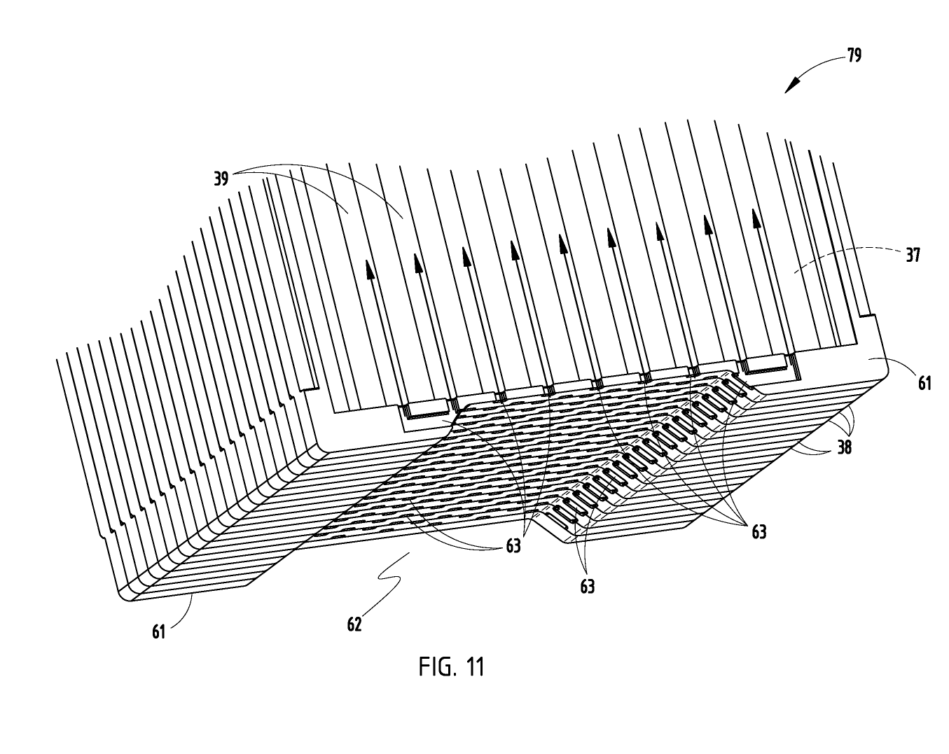

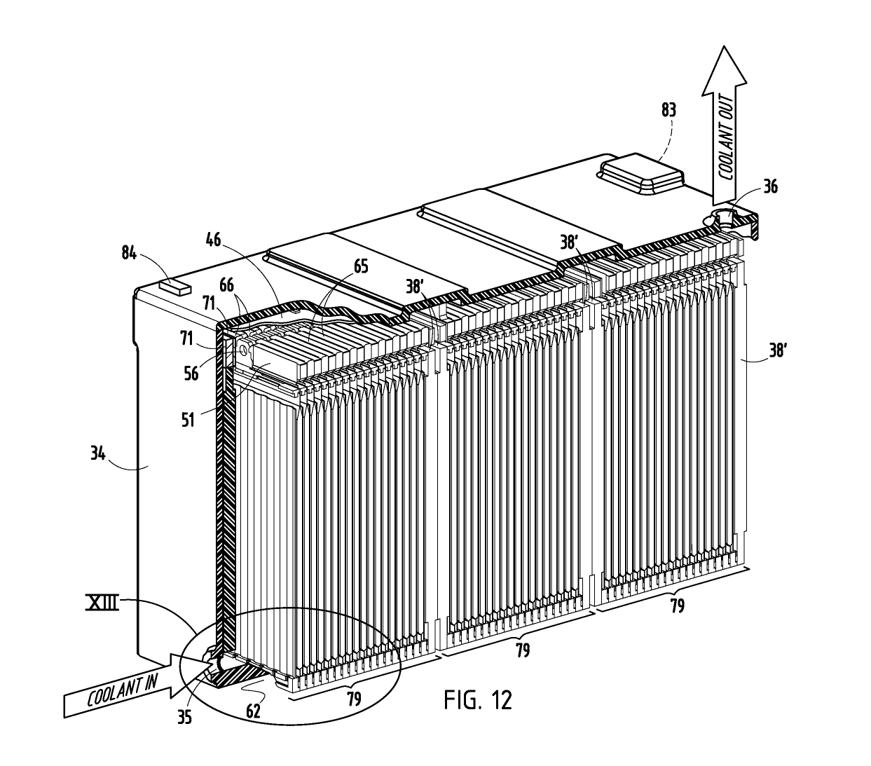

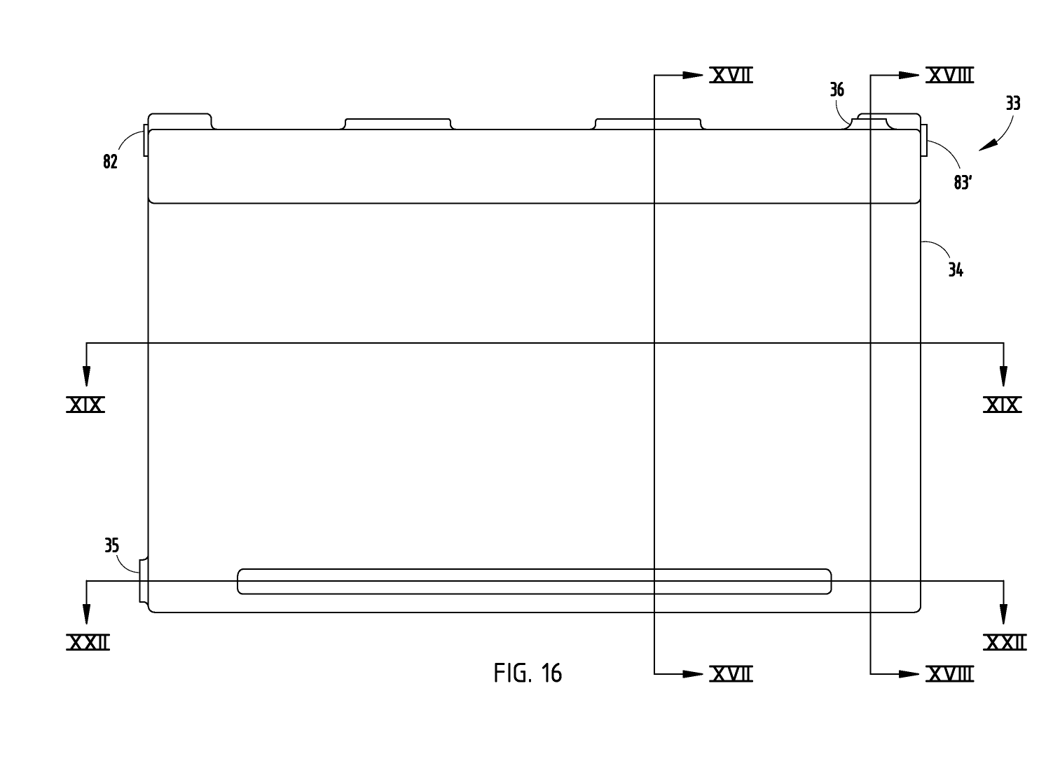

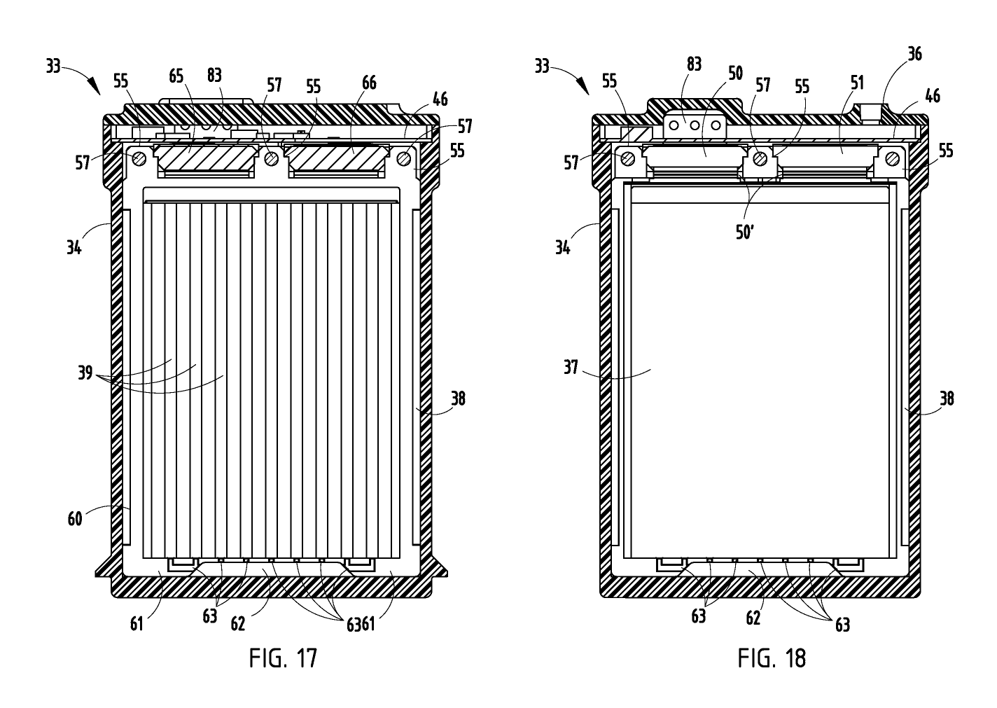

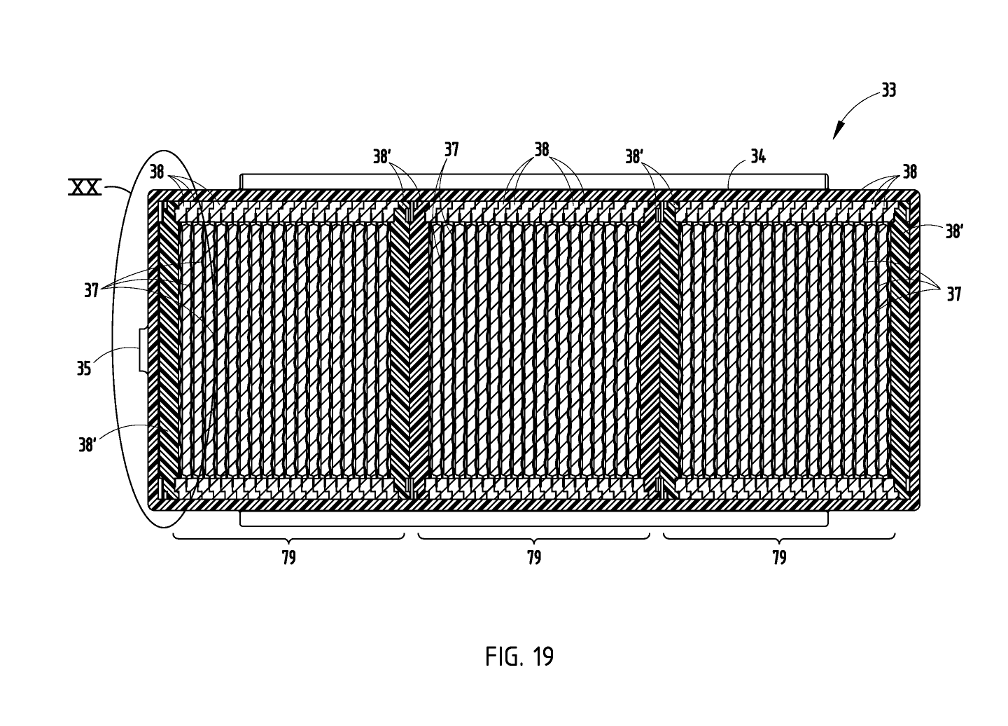

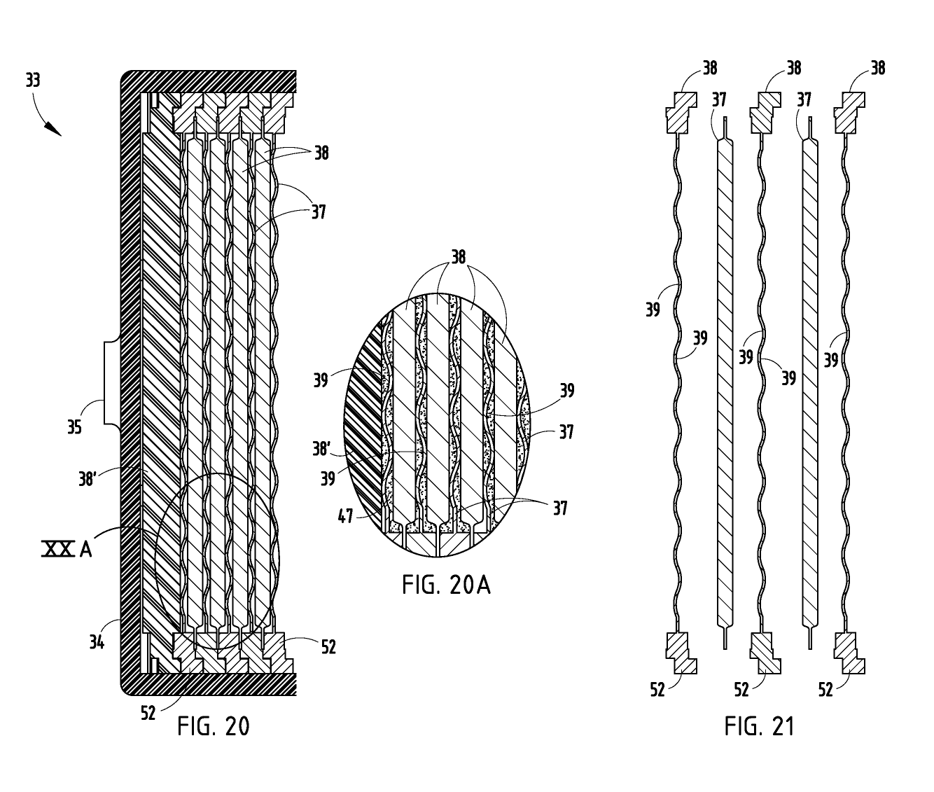

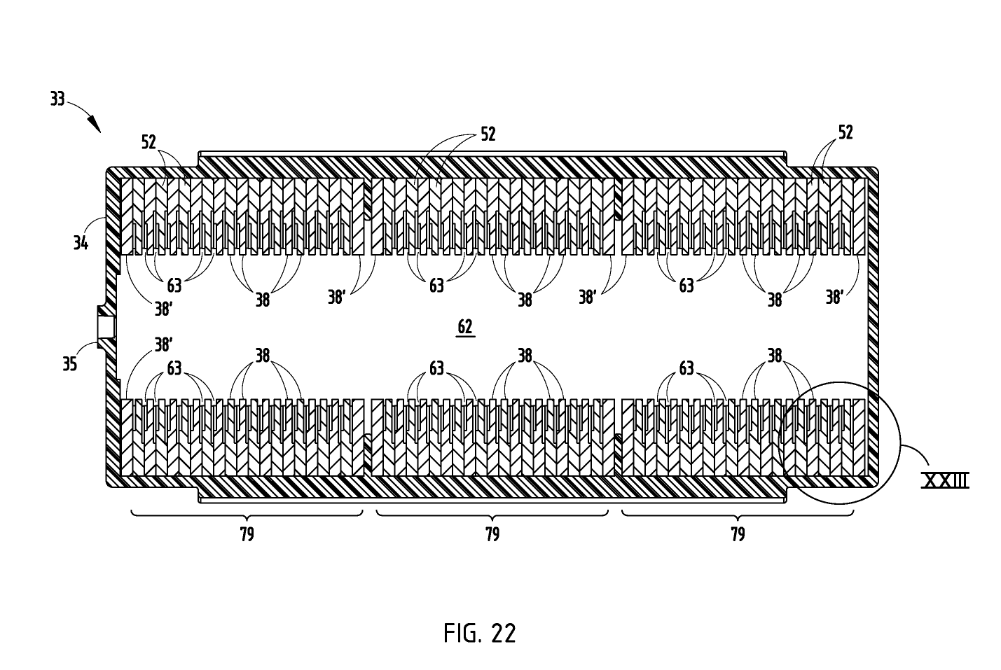

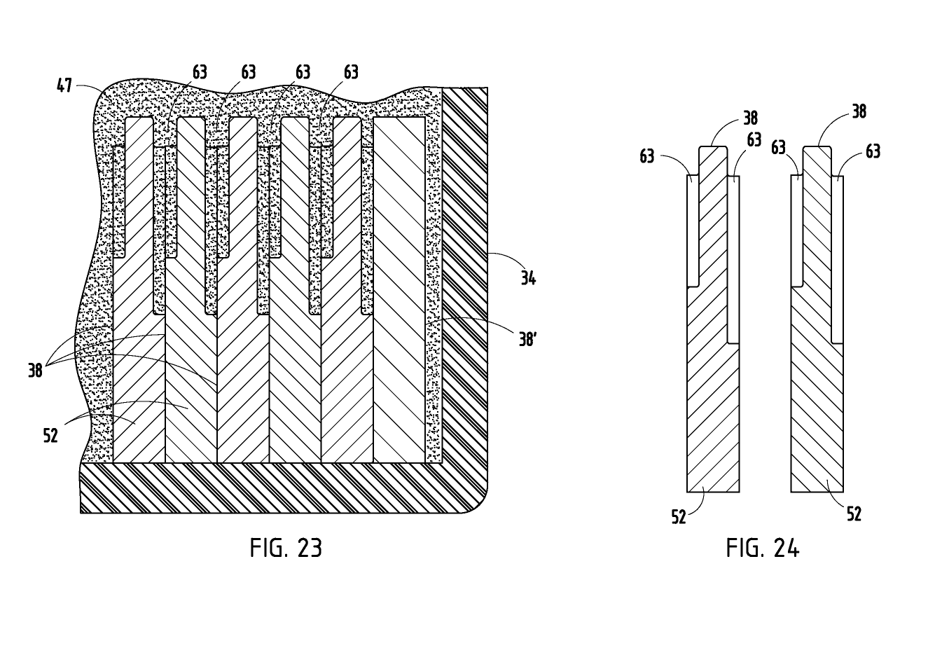

FIGS. 11-15 show flow of liquid 47 into, through, and out of the case 34. In particular, FIGS. 12 and 15 show flow of liquid 47 into inlet port 35, longitudinally along bottom channel 62, upward through several channels 54, up past flanges 50-51 and past and around the circuit board 46 to outlet port 36. FIGS. 16-24 show additional details of components of the illustrated embodiment, including interfitting and cooperating features of mating/adjacent parts.

FIG. 25 is a schematic view of a vehicle incorporating the present battery apparatus as part of a battery driven passenger vehicle 30 with wheels, including the battery apparatus 33, an electric motor/engine 32, a pump 40, heat-exchanger 41 fluid lines 42-44 connecting same, sensors S1-S3, and controller 45 for controlling battery temperature and pump operation.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A battery configuration comprising:
a plurality of battery cells;
a battery case defining a space and housing the battery cells; and
a thermally-conductive electrically-insulating liquid flooding the space and coating the battery cells for conducting heat away from the battery cells while maintaining electrical integrity.

2. The battery configuration defined in claim 1, including a liquid motivating system including a pump pumping liquid continuously through the battery case.

3. The battery configuration defined in claim 2, wherein the liquid includes a paraffin material.

4. The battery configuration defined in claim 1, including a plurality of spacers that, with the battery cells, define parallel flow channels along individual ones of the battery cells.

5. The battery configuration defined in claim 4, wherein the spacers define a bottom channel, a top space, and wherein the parallel flow channels extend between the bottom channel and the top space.

6. The battery configuration defined in claim 1, including a circuit board in the case that is also flooded by the liquid.

7. A temperature-controlled battery configuration, comprising:
a plurality of battery cells, with conductive electrodes for accessing electrical power capacity of the cells;
a system of interconnecting hardware that allows multiple cells to function together as an electrical storage battery;
a control system including circuitry that is electrically connected to the cells for at least one of monitoring or controlling the battery configuration;
a container sized and shaped to contain and encapsulate the cells along with the system of interconnecting hardware and at least a portion of the control system; and
an electrically-insulating heat-transfer liquid filling the container and having direct contact to the cells, the hardware, and the portion of the control system in the container.

8. A temperature-controlled battery configuration, comprising:
a plurality of standard Lithium-ion cell packs with conductor tabs for accessing electrical power stored in the cell packs;
at least one spacer between and separating adjacent ones of each of the cell packs, the spacer having a perimeter that holds at least a part of a weight of the adjacent cell packs and that defines with the adjacent cell packs a plurality of channels;
positive and negative electrical conductors connecting the conductor tabs; and
a casing containing the cell packs, spacers, conductors and being adapted for connection to a pump and heat exchanger;
electrically-insulating thermally-conductive fluid, the case including an inlet and outlet connected to the channels for passing the electrically-insulating thermally-conductive fluid therethrough.

9. The battery configuration defined in claim 8, including a system having a pump and lines filled with the electrically-insulating thermally-conductive fluid for pumping through the inlet and the channels past the cell packs and through the outlet.

10. The battery configuration defined in claim 9, wherein the fluid is a liquid, and wherein the system includes a heat exchanger to remove or supply heat to the liquid.

11. The battery configuration defined in claim 10, wherein the liquid is a paraffin type material.

12. The battery configuration defined in claim 9, wherein the system is configured to selectively heat or cool the liquid.

13. The battery configuration defined in claim 8, including slugs that are electrically-conductive-and-thermally-conductive and others that are electrically-insulating-and-thermally-conductive.

14. The battery configuration defined in claim 8, including end spacers for clamping together a stacked arrangement of cells and spacers.

15. The battery configuration defined in claim 8, including a circuit board positioned in the casing and operably connected to the system for controlling a temperature of the fluid.

16. The battery configuration defined in claim 15, wherein the circuit board includes temperature and voltage sensors.

17. The battery configuration defined in claim 15, wherein the circuit board includes thermistors and spring contacts mounted to an underside of the circuit board.

18. The battery configuration defined in claim 8, wherein the spacers and cells define channels for directing flow of the fluid.

19. A temperature-controlled battery system, comprising:
a battery including a casing with an inlet and an outlet, and a plurality of standard Lithium-ion cell packs with channels therebetween positioned in the casing, the channels being adapted to communicate an electrically-insulating thermally-conductive fluid from the inlet past the cell packs to the outlet for controlling a temperature of the cell packs including directly impinging the fluid against outer surfaces of the cell packs;
a pump;
a heat exchanger; and
fluid lines operably connecting the pump, the inlet, the outlet and the heat exchanger; the lines being filled with the thermally-conductive fluid.

20. A vehicle comprising:
a vehicle body with wheels and seating that is adapted to carry passengers and/or cargo;
an electric battery-powered motor for powering the vehicle;
a temperature-controlled battery configuration comprising a battery including a casing with an inlet and an outlet, and an alternating arrangement of Lithium-ion cell packs and spacers with at least one spacer between each of the cell packs, the spacers supporting at least part of a weight of the cell packs in the casing, the spacers further defining with adjacent ones of the cell packs a plurality of channels;
a thermally-conductive electrically-insulating fluid for passing into the inlet, along the channels and against an outer surface of the cell packs, and to the outlet for controlling a temperature of the cell packs;
a fluid pump for pumping the fluid;
a heat exchanger for controlling a temperature of the fluid;
fluid lines operably connecting the pump, the inlet, the outlet and the heat exchanger; the lines being filled with the thermally-conductive fluid; and
a controller for controlling the pump and flow of the fluid to control a temperature of the battery configuration to maintain a desired temperature range of the cell packs.

21. A method of regulating temperature in a multiple-cell battery comprising steps of:
providing a battery with multiple cells spaced apart by spacers, at least a part of a weight of the cells being supported by the spacers and a combination of the cells with adjacent ones of the spacers forming fluid-conducting channels;
providing an electrically-insulating heat-transfer fluid;
passing the fluid through the channels past an outer surface of each of the cells under adjacent ones of the spacers at a rate sufficient to regulate cell temperature, including deliberately and directly impinging the fluid against the outer surfaces of the cells, but with the fluid not significantly interacting with the cell's electrical charge nor detrimentally affecting the cell's materials of construction; and
controlling a temperature of the fluid to achieve temperature control of the cells.
